(19) United States
(12) Patent Application Publication
(10) Pub. No.: US 2024/0127320 A1
(43) Pub. Date: Apr. 18, 2024

(54) PURCHASING PERMISSION UTILIZING A NON-FUNGIBLE TOKEN SYSTEM AND METHOD

(71) Applicants: James Sullivan, Edina, MN (US); Jason Holmers, Edina, MN (US)

(72) Inventors: James Sullivan, Edina, MN (US); Jason Holmers, Edina, MN (US)

(21) Appl. No.: 17/964,995

(22) Filed: Oct. 13, 2022

(51) Int. Cl. G06Q 30/06

(52) U.S. Cl. CPC G06Q 30/0637; G06Q 30/0609

(57) ABSTRACT

A purchasing permission utilizing a non-fungible token system includes a method of securely transferring a good comprising the steps of providing a physical product and creating a non-fungible token (NFT) associated with the physical product. The NFT is transferred to a prospective buyer of the physical product and the identification information of the prospective buyer is recorded in a blockchain which contains the NFT. The physical product is offered for sale on a digital platform the prospective buyer is allowed to purchase the physical product by validation of the NFT's association with the physical product.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to digitally secure limited good purchasing system and more particularly pertains to a new digitally secure limited good purchasing system utilizing a non-fungible token as verification for the purchasing of a physical good.

### (2) Description of Related Art Including Information Disclosed Under 37 CFR 1.97 and 1.98

The prior art relates to systems that have utilized digital keys for allowing access to purchasing systems. However, the ability to copy or thieve digital keys makes their usage more difficult to monitor and control. Moreover, digital keys are not immune to being unlocked. Therefore a more secure method is needed to not only allow a person access to an online shopping forum but which further allows for verification and tracking of the person's identity to ensure purchased physical goods are distributed correctly. Additionally, the system should be able to authenticate the underlying good being purchased.

### BRIEF SUMMARY OF THE INVENTION

An embodiment of the disclosure meets the needs presented above by generally comprising a method of securely transferring a good comprising the steps of providing a physical product and creating a non-fungible token (NFT) associated with the physical product. The NFT is transferred to a prospective buyer of the physical product and the identification information of the prospective buyer is recorded in a blockchain which contains the NFT. The physical product is offered for sale on a digital platform the prospective buyer is allowed to purchase the physical product by validation of the NFT's association with the physical product.

In another embodiment, the method includes creating a primary physical product and a plurality of non-fungible tokens (NFTs), wherein each of the NFTs is associated with the primary physical product. The NFTs are transferred to one or more prospective buyers of the primary physical product and their identification information is recorded in a blockchain containing the NFTs. A plurality of secondary physical products is offered for sale on a digital platform, wherein the secondary physical products define a limited quantity of articles theme related to the primary physical product. The prospective buyers are allowed to purchase the secondary physical products using a held NFT, wherein each NFT is related to and allows for the verification and purchase of a single one of the secondary physical products. An amount of the secondary physical products is created to equal to the number of secondary physical products purchased by the prospective buyers. The purchased ones of the secondary physical products are thereafter deployed to verified ones of the prospective buyers.

An embodiment of a system of the disclosure comprises a physical product, a computing device and a database that is in remote communication with the computing device. The computing device utilizes an access interface configured to allow the computing device to remotely access information regarding the physical product, creates a non-fungible token (NFT) associated with a copy of the physical product, sends to the computing device the NFT to be held by a prospective buyer of the copy, and allows the prospective buyer having possession of the NFT a permission to initiate a purchase of the copy.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a schematic view of a purchasing permission utilizing a non-fungible token system and method according to an embodiment of the disclosure.

FIG. 2 is a schematic view of an embodiment of the disclosure.

### DETAILED DESCRIPTION OF THE INVENTION

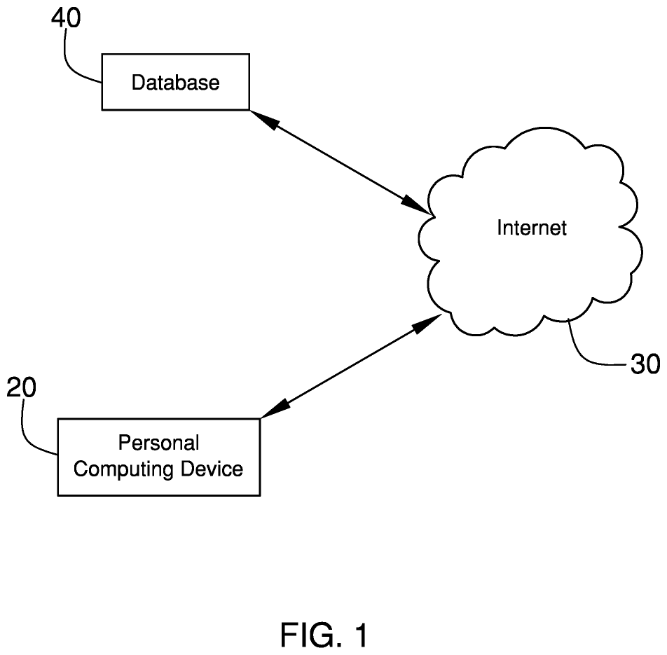

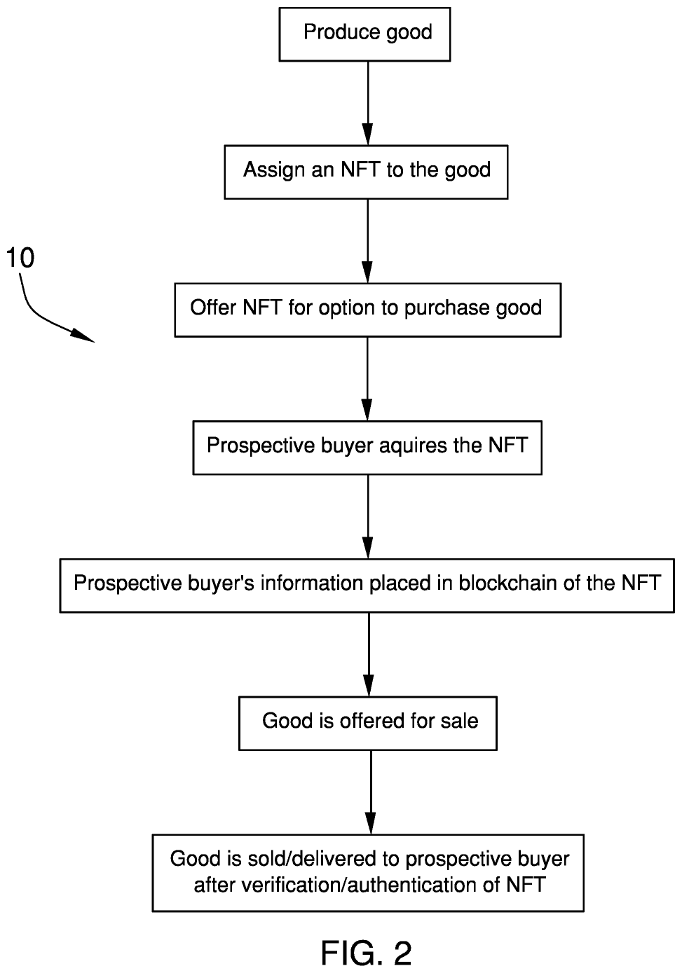

With reference now to the drawings, and in particular to FIGS. 1 through 2 thereof, a new digitally secure limited good purchasing system embodying the principles and concepts of an embodiment of the disclosure and generally designated by the reference numeral 10 will be described.

As best illustrated in FIGS. 1 and 2, the purchasing permission utilizing a non-fungible token system 10 and method generally comprises a secure transaction method whereby a non-fungible token (NFT) is utilized to provide permission to a potential or prospective buyer of a physical product to purchase a physical good. An NFT cannot be copied and each is unique. Furthermore, processing safeguards related to blockchain systems inhibit “double spending” whereby the same NFT could be used for more than one transaction. Namely, the system 10 allows a seller to control who may buy a physical product, control the number of physical products being sold, and ensure securing transfer of ownership of the physical product to the prospective purchaser should the physical good be purchased. The term “physical product” is intended to define an actual physically tangible item as opposed to a digital good.

The physical good may comprise any good but will typically comprise a limited run of a small number of copies of the physical good or may comprise theme related goods. Them related goods may include, for example, a plurality of rare coins having similar origins, dates, and grading, or different cover variations of a comic book, and the like. Generally, theme related goods will have a similar or identical value relative to each other such that the purchaser of one related good will pay the same monetary value as a purchaser of a different one of related goods.

Alternatively the physical good may comprise a single, original good. The single, original good may or may not be a collectible item or may be an item that has the potential to be a collectible item.

More typically, the physical good is the first of multiple identical goods or a limited run of identical goods. For explanatory purposes, the physical good first created will be defined as the primary physical good and all copies thereafter will be defined as secondary physical goods. The primary physical good will almost always be an actual, first produced version of the good which is suitable sale and therefore would not include any versions of the physical good that were deemed unfit for sale and discarded or otherwise destroyed. There may be some instances, such as will a comic book, where the first physical good is a digital version of the comic book which is not sellable and only represents what will be printed as a limited run of the secondary physical goods. Generally, however, the primary physical good will be a consumer ready, physical version of the good in question. For example, a producer/seller may create any reproducible good including a comic book, a figurine, a poster, an item of clothing, etc. that can be readily copied as needed or copied in advance to create a limited run of the physical product.

Because the primary physical good may be sold as well as the secondary physical goods as they are identical with each other, some examples below will consider the primary and secondary physical goods interchangeable and such will be designated only as a “physical good”, and it is understood that such a designation includes both types of goods. However, an embodiment is contemplated wherein the secondary physical goods may be distinguishable from each other such as by numbering or designation wherein each secondary physical good is provided is own unique identifier such as a code or number.

The system 10 includes a computing device and a database 40 in communication with each other to effect the sale of the physical good to a prospective buyer. The computing device 20 may include a personal computer, cellular phone, tablet computer, or any other personal computing device 20 used for running programs and which will have the ability to connect to the internet 30. The database 40 will be conventional and may include a cloud-based database 40. The database 40 and the computing device will be in remote communication with each other usually via an internet connection. An access interface utilized by the computing device will provide data transfer between the computing device and the database 40 in a manner that is user friendly. The access interface may include a program or application will usually be internet based, downloadable onto the computing device, or, more often, a combination of both.

The system 10 will further take advantage of non-fungible tokens (NFTs) to ultimately create a secure transfer of the physical product to the correct prospective buyer. NFTs, being non-fungible, are each unique, digital data recorded on a blockchain. An NFT cannot be replaced and therefor the owner of the NFT will have the only copy of the NFT. The system 10 uses this uniqueness of an NFT to sell, and distribute physical objects to select persons or entities, and the system 10 can further utilize NFTs to produce the physical objects on demand.

In one embodiment, a seller or producer will offer a primary physical good for sale. Prospective buyers will electronically register with the seller and indicate a desire to purchase the physical good. The seller will provide a finite number of NFTs, equal to the number of physical goods in a limited run, to distribute to the prospective buyers. Should a prospective buyer receive an NFT, that prospective buyer's information is recorded on the blockchain so that the prospective buyer has access to their specific NFT. An NFT holding prospective buyer may then access the database 40 to initiate a purchase of one of the secondary physical goods using the NFT. The access interface will verify that the prospective buyer in fact holds the NFT and upon verification will allow the prospective buyer to purchase the secondary physical product. A purchaser of the secondary physical product will thereafter receive the secondary physical product. When each secondary physical product has an identifier that is unique to the other secondary physical products, the NFT will incorporate that unique identifier.

As an example, the seller may wish to sell a unique basketball shoe having a limited run totaling no more than 300 pairs of basketball shoes. The seller will generate 300 NFTs associated with the basketball shoe and will distribute the 300 NFTs to prospective buyers. This not only ensures an orderly process for controlling sales of the basketball shoe, but will allow the seller to determine who will receive each NFT and as such provides the opportunity to create a vetting process to potentially increase the value of the physical goods after sale. The holders of the NFT are thereafter after allowed to buy the pairs of basketball shoes using their NFTs as verification that they have permission to buy the basketball shoes.

In an alternate example using the basketball shoe as above, the system 10 may instead be used to sell the NFT itself from the seller to the prospective buyer. Thus, the transaction of funds from the prospective buyer to the seller for the basketball shoe will be paid for at the time of the NFT transfer itself. Thereafter, the holder of the NFT will use the NFT to verify their right of ownership to the physical good, i.e. the pair of basketball shoes and, subsequently, receive the physical good.

In yet another alternate embodiment, the seller may first require the purchase of the NFT itself before allowing purchase of the physical good. In such an embodiment, the purchase of the NFT provides the prospective buyer the right to buy the physical good but only after first obtaining the NFT for a fee. Such a process will assist a seller in vetting prospective buyers and retain NFTs for those entities who have the funds and the actualized strong desire to obtain the physical good.

For the seller, an advantage of the above is that only enough of the physical goods are produced as there are issued NFTs. Moreover, depending on the physical good, the seller may delay production of each secondary physical good until an associated NFT has been granted to and/or used by the prospective buyer. Thus, the seller will begin with the primary physical good as a “model” for purchase. The seller, depending on their chosen process, can then produce the first one of the secondary physical goods when a prospective buyer receives an NFT or uses the NFT to verify their identity and purchases the yet to be produced secondary physical good. This process will prevent the seller from producing goods that will not be sold, lowers operating costs for the seller, and provides the seller with the ability to later restrict the number of goods sold, should demand be lower, in an effort to increase the value of the physical goods already purchased.

Generally then, the system 10 is used to provide a potential buyer of a physical good with an NFT giving the potential buyer the verification needed to buy the good. Once the good is purchased, the NFT also can be used to prove ownership and the authenticity of the purchased good. That is, once the buyer has the purchased good, the good's association with a specific NFT provides proof that the good is authentic and the NFT may be transferred with the good to subsequent buyers of the same good. Moreover, the good not need to be produced until the NFT has been awarded and/or used to lower the carrying costs of the goods. The system 10, by using the uniqueness of an NFT, securely ensures that the goods are only purchased and delivered to the rightful owner of the goods while controlling both the number of goods produced and who can be a potential buyer.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A method of securely transferring a good comprising the steps of:
providing a physical product;
creating a non-fungible token (NFT) associated with the physical product;
transferring the NFT to a prospective buyer of the physical product;
recording identification information of the prospective buyer in a blockchain on which is contained the NFT;
offering for sale the physical product on a digital platform; and
allowing purchasing of the physical product by the prospective buyer by validation of the NFT's association with the physical product.

2. A method of securely transferring a good comprising the steps of:
creating a primary physical product;
creating a plurality of non-fungible tokens (NFTs), each of the NFTs being associated with the primary physical product;
transferring the NFTs to one or more prospective buyers of the primary physical product;
recording identification information of the one or more prospective buyers in a blockchain on which is contained the NFTs;
offering for sale a plurality of secondary physical products on a digital platform, the secondary physical products being a limited quantity of articles being theme related to the primary physical product;
allowing purchasing of the secondary physical products by only one or more of the prospective buyers, wherein each NFT is related to and allows for the verification and purchase of a single one of the secondary physical products;
creating multiple ones of the secondary physical products equal to the number of secondary physical products purchased by the prospective buyers; and
deploying to verified ones of the prospective buyers purchased ones of the secondary physical products.

3. The method of securing transferring a good according to claim 2, wherein the secondary physical products are copies of the primary physical product.

4. A system for securely transferring ownership rights in a specific good, the system comprising:
a physical product;
a computing device;
a database being in remote communication with the computing device;
the computing device utilizing an access interface, the access interface being configured to:
allow the computing device to remotely access information regarding the physical product;
create a non-fungible token (NFT) associated with a copy of the physical product;
send to the computing device the NFT to be held by a prospective buyer of the copy; and
allow the prospective buyer having possession of the NFT a permission to initiate a purchase of the copy.
